(19) United States
(12) Patent Application Publication
(10) Pub. No.: US 2017/0323363 A1
(43) Pub. Date: Nov. 9, 2017

(54) COLLABORATIVE MANIPULATION OF MEDIA FILES

(71) Applicant: Oct8ne Inc., Terrace Park, OH (US)

(72) Inventor: Domingo Obradors Giró, Barcelona (ES)

(21) Appl. No.: 15/148,272

(22) Filed: May 6, 2016

(51) Int. Cl. G06Q 30/06; G06F 3/0484; G06F 17/30; H04L 29/06; H04L 12/58

(52) U.S. Cl. CPC G06Q 30/0621; H04L 65/1083; H04L 51/046; G06F 3/04842; G06F 17/30867; G06Q 30/0643

(57) ABSTRACT

Browsing session data of a first user of a first client device at an enterprise website is accessed together with user information associated with the first user. The accessed data is used to determine that the first user would like to collaborate with a second user of a second client device. A first data file is retrieved from the enterprise based on the session data and a data type of the first data file is determined. Metadata associated with the first data file is accessed from the enterprise and one or more sources of data files are identified based on the data type and the metadata. A first collaboration widget is transmitted to the first device and a second collaboration widget to the second device. The first and second client devices access a collaboration user interface with access to the file sources using the first and second collaboration widgets respectively.

### TECHNICAL FIELD

The subject matter disclosed herein generally relates to concurrently sharing, viewing, editing and discussing media files between users of electronic devices. More specifically, the present disclosure describes systems and methods for transmitting platform-independent collaboration widgets to multiple client devices via which the client devices may access a server-generated collaboration user interface for viewing and manipulating media files from arbitrary sources.

### BACKGROUND

Conventionally, shopping for products “online” over the internet has been quite different from in-store shopping in regard to the personalized attention that an in-store customer can receive from a sales agent that is knowledgeable in regard to the product segment that a customer is interested in. Furthermore, despite the fact that customer interactions with sales agents are possible online, limitations are often present. For example, the media content that may be jointly accessed by a customer and sales agent is often limited to content from a website that the sales agent is associated with. Therefore, when most online shoppers visit the web sites of online vendors, they are not provided with sufficient options for viewing and/or discussing other products for comparative purposes (e.g., products associated with different vendors) that the customer may think relevant to their shopping experience.

### BRIEF DESCRIPTION OF THE DRAWINGS

The present disclosure is illustrated by way of example, and not by way of limitation, in the figures of the accompanying drawings, in which:

FIG. 1 is a use-case diagram showing a network system configured to transmit data over a network and consistent with some embodiments for the shared viewing and manipulating of media files.

FIG. 2 is a block diagram depicting a network system having a client-server architecture, according to one embodiment, configured to provide a collaboration user interface for the shared viewing and manipulating of media files.

FIG. 3 is a block diagram depicting a network system having a client-server architecture, according to one embodiment, configured to provide a collaboration user interface for the shared viewing and manipulating of media files.

FIG. 4 is a block diagram depicting a network system having a client-server architecture, according to one embodiment, configured to provide a collaboration user interface for the shared viewing and manipulating of media files.

FIG. 5 is a block diagram depicting a network system having a client-server architecture, according to one embodiment, configured to provide a collaboration user interface for the shared viewing and manipulating of media files.

FIG. 6 is a block diagram depicting a network system having a client-server architecture, according to one embodiment, configured to provide a collaboration user interface for the shared viewing and manipulating of media files.

FIG. 7 is a display diagram illustrating an embodiment of the collaboration user interface provided to a customer or sales agent via a client device.

FIG. 8 is a ladder diagram illustrating a method, in accordance with an example embodiment, for connecting a customer with a sales agent for the shared viewing and manipulating of media files.

FIG. 9 is a ladder diagram illustrating a method, in accordance with an example embodiment, for initially selecting and then changing the files for shared viewing and manipulating in a collaboration user interface.

FIG. 10 is a ladder diagram illustrating a method, in accordance with an example embodiment, for selecting a product for purchase based on uploading a custom file for shared viewing and manipulating in a collaboration user interface.

FIG. 11 is a ladder diagram illustrating a method, in accordance with an example embodiment, for searching arbitrary sources for media files and converting/adapting a selected file for shared viewing and manipulating in a collaboration user interface.

FIG. 12 shows a diagrammatic representation of a machine in the example form of a machine or computer system within which a set of instructions may be executed causing the machine to perform any one or more of the methodologies discussed herein.

FIG. 13 is a block diagram illustrating a mobile device, according to an example embodiment.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The collaborative manipulation of media files by multiple client devices may be facilitated over a network in a platform-independent manner. In other words, the client devices are not limited to using any particular operating system or other particular software in order to collaboratively manipulate files. As long as the client device has a browser type application for viewing/manipulating media files, for example, a hyper-text markup language (“HTML”) browser, it may participate in the collaborative file manipulation. A link is established between the client devices and at least one server by using widgets (e.g., small software applications) that can be rapidly distributed from the server(s) to requesting client devices. The widgets may be the same for two client devices to collaborate or the widgets may be different for a first client device (e.g., website customer) and a second client device (e.g., website sales agent). The second client device may already have such a widget if the user of the second client device is a sales agent; otherwise a “sales agent” widget can be provided by the server. The widgets allow communication (e.g., including transmission of media content) between the client devices and the server(s) (and therefore between the client devices via the server(s)) by using a server-generated collaboration user interface that enables the shared viewing/manipulating of files without requiring any particular software on the client devices other than a browser for viewing media files.

According to an embodiment, a method for collaborative manipulation of media files may be invoked during a browsing session of a customer at an electronic commerce (e-commerce) website. A “browsing session” is a continuous connection from a browser to a server over a period of time. The client devices of the customer and a selected sales agent associated with the website may both display, on a browser of the respective client devices, a shared view of a media file in a collaboration user interface. In this way the customer and the sales agent can both view and manipulate the same media file displayed via a browser on their respective client devices. The server(s) accesses browsing session data (e.g., clickstream data) of the browsing session from an enterprise's e-commerce website and may also access customer data from the enterprise, e.g., from an electronic customer relationship management (e-CRM) system of the enterprise. The session data may include data associated with goods or services the customer has searched or viewed during a browsing session at the website and metadata about the browsing session, such as a pattern of searches by the customer. The server(s) may determine from the accessed data, for example based on pre-determined matching rules, that the customer wants to collaborate with a sales agent during the browsing session.

The server(s) may then refer to data associated with available sales agents, for example data regarding their past performance, their product expertise, or previous interaction with the customer, in order to match the customer with at least one sales agent, based on the customer data, session data, and sales agent, and facilitate collaboration between the sales agent and the customer as described above. The server(s) may also provide data regarding other sources of products or services the customer may be interested in viewing (both internal and external to the enterprise) for comparative purposes.

### Overview

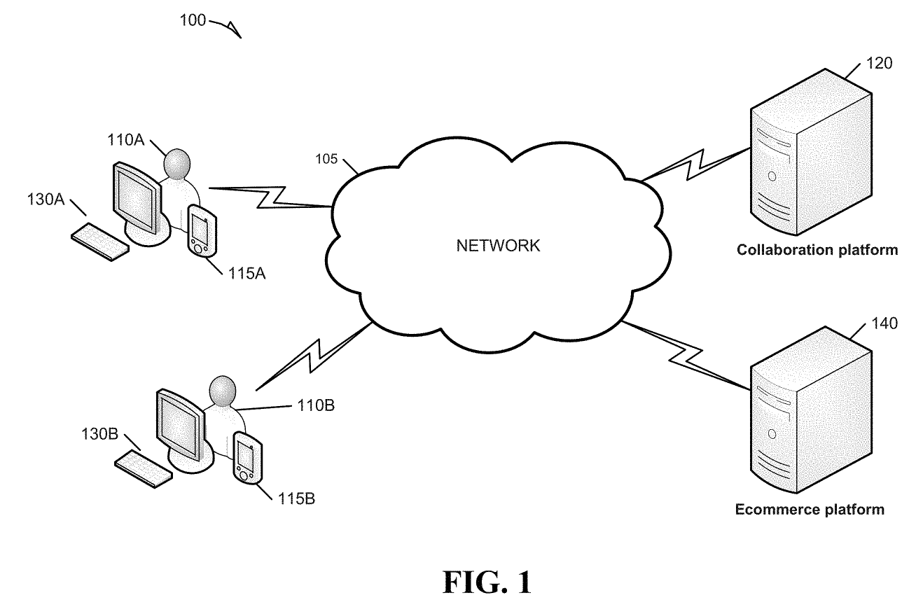

FIG. 1 is a use-case diagram showing a network system 100 configured to transmit data over a network 105 (e.g., the internet) and consistent with some embodiments for the shared viewing and manipulating of media files. At least one remote server 120 supports a collaboration platform for generating a collaboration user interface and for transmitting collaboration widgets to client devices 115 so that the client devices 115 can access the collaboration user interface. The client device 115A may be a mobile device or a more static client device 130A (e.g., a desktop computer) of a customer 110A of an e-commerce website of an ecommerce platform hosted at a platform server 140 accessed over network 105. The client device 115B may be a mobile device or a more static client device 130B of a sales agent 110B associated with the e-commerce website. The remote server 120 may (e.g., based on a customer request) access data associated with the browsing session of customer 110A, data associated with customer 110A, and data associated with available sales agents, for example sales agent 110B, in order to match the customer 110A with the sales agent 110B.

The remote server 120 can create a link between itself and the client devices (e.g., 130A and 130B) by transmitting collaboration widgets to the respective client devices 130A and 130B. The collaboration widgets allow communication (e.g., including transmission of media content) between the client devices 130A and 130B and the remote server 120 (and therefore between the client devices 130A and 130B via the remote server 120) via a collaboration user interface that enables the shared viewing/manipulating of media files from arbitrary sources without requiring any particular software installed on the respective client devices 130A and 130B. For example, collaboration widgets could update the view of a media file on a client device 115A or 115B based on changes to the view of a file by customer 110A or sales agent 110B and transmit (e.g., periodically or trigger-based) information regarding the changes to the remote server 120 accordingly. In a similar manner, the collaboration widgets could poll the remote server 120 (or vice-versa) for information regarding changes to the view of a file by customer 110A or sales agent 110B and transmit this information to the client device 115A or 115B (e.g., to the one that did not make the change) so that the client device 115A or 115B can update its view of the shared media file to incorporate the changes. Although only the dual client device situation is described here, an arbitrary number of client devices could collaborate with each other via such collaboration widgets.

### System Architecture

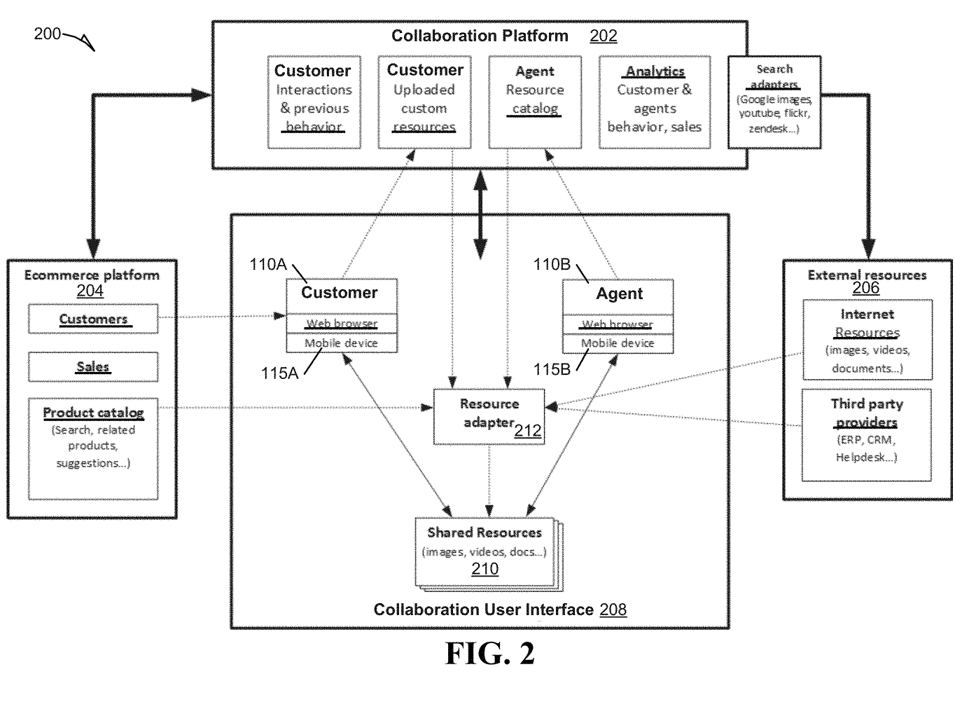

FIG. 2 is a block diagram depicting a network system 200 having a client-server architecture, according to one embodiment, configured to provide a collaboration user interface for the shared viewing and manipulating of media files. The elements in FIG. 2 include some elements from FIG. 1; these elements are labeled with the same identifiers. A collaboration platform 202 (e.g., a collaboration module residing on at least one remote server 120) is configured to communicate with two or more client devices 115A and 115B associated with customer 110A and sales agent 110B respectively. The collaboration platform 202 is also configured to communicate with an ecommerce platform 204 (an ecommerce module residing on at least one platform server 140) that hosts an e-commerce website visited by customer 110A during a browsing session. The ecommerce platform 204 also stores data regarding a “Product catalog” (e.g., products available for purchase on the e-commerce website), “Sales” (e.g., at the e-commerce website), and “Customers” (e.g., that have visited or made purchases on the website). The collaboration platform 202 can access session data from a browsing session of the customer 110A at the e-commerce website or other data associated with customer 110A from the “Customers” data at the ecommerce platform 204. The collaboration platform 202 can store the accessed data associated with customer 110A and the browsing session as “Interactions and previous behavior” of customer 110A with the ecommerce platform 204.

The collaboration platform 202 can then determine, based on the “Interactions and previous behavior” of customer 110A (including the data from the browsing session), that the customer 110A would like to collaborate with a sales agent 110B (e.g., the customer 110A has searched several products without making a purchase, unlike in previous interactions). The selection of sales agent 110B for collaboration with customer 110A may be based on “Analytics” comprising an analysis of the behaviors (including past sales) of the sales agent 110B and the customer 110A or other customers determined to be similar to customer 110A. The collaboration platform 202 can then retrieve a first data file from the ecommerce platform 204 (e.g., from the “Product catalog”) based on the browsing session data (e.g., a data file associated with a product that the customer 110A has viewed or searched during the browsing session at the e-commerce website) and the interactions and previous behavior of customer 110A (e.g., the customer 110A usually prefers a certain brand). The collaboration platform 202 then determines a data type of the first data file (e.g., an image format, document format or video format) and also accesses, from the ecommerce platform 204, metadata associated with the first data file (e.g., how many times it has been viewed or a business associated with the data file). The collaboration platform 202 can then identify one or more shared resources 210 of data files from external resources 206, from “Uploaded custom resources” comprising data files stored at the collaboration platform 202 by customer 110A (or another customer determined to be similar), or from a “Resource catalog” comprising data files stored at the collaboration platform 202 by sales agent 110B based on the first data file, the data type and the metadata (e.g., similar files that are the most popular or otherwise relevant). The external sources of data files may include nearly any source of data files that can be searched using “Search adapters” located at the collaboration platform 202, such as “Internet Resources” of images, documents, videos, etc., or “Third party providers” of such files, e.g., Customer Relationship Management (CRM) system of an enterprise.

The collaboration platform 202 can then generate a collaboration user interface 208 providing: options (e.g., user interface elements) for viewing and manipulating the first data file in a respective “Web browser” of client devices 115A and 115B by making use of a resource adapter 212 to modify the format of the first data file if that is needed (or even just helpful, such as for faster processing) for viewing and manipulating the file in the “Web browsers”. The collaboration platform 202 also provides (in the collaboration user interface 208) a user selectable list of the one or more shared resources 210 of data files that may be jointly viewed and manipulated by the customer 110A and the sales agent 110B. As noted above, different collaboration widgets may be provided to the client devices 115, 130 of the customer 110A and the sales agent 110B. For example, a collaboration widget for the client device 115B of sales agent 110B may provide access to additional features in the collaboration user interface 208, such as a display of a status indicator for customer 110A based on an activity of the customer 110A in a specified context. If the context is an e-commerce website (e.g., of the ecommerce platform 204), then the activity could be adding a product to a shopping cart or purchasing a product, and the indicators for each could be “purchasing” or “purchased”. Alternatively some activities could result in a status indicator in any context, such as minimizing or exiting the collaboration user interface 208, both of which could be indicated by “not interested” or some other similar indicator.

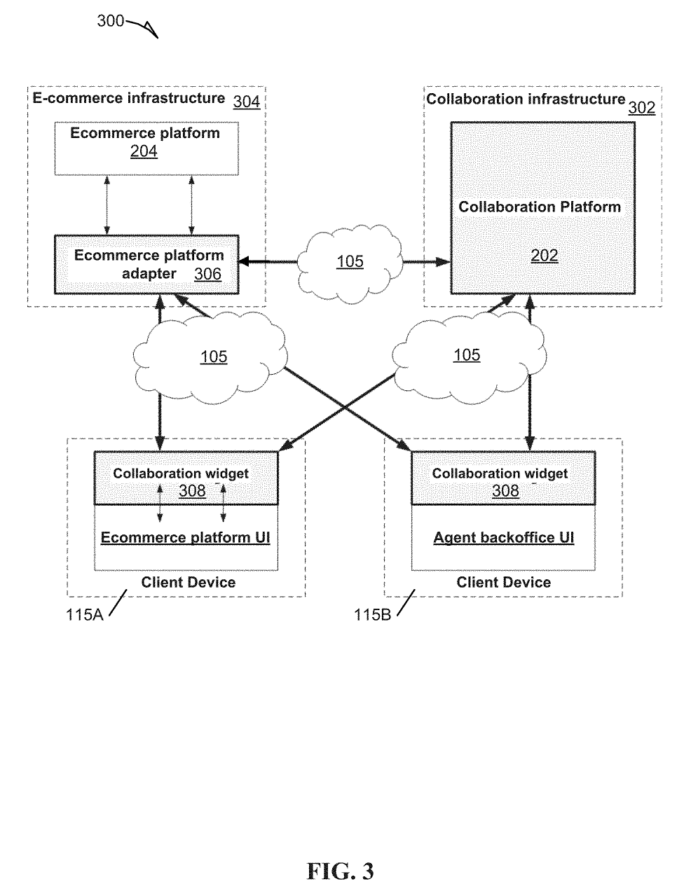

FIG. 3 is a block diagram depicting a network system 300 having a client-server architecture, according to one embodiment, configured to provide a collaboration user interface for the shared viewing and manipulating of media files. The elements in FIG. 3 include some elements from FIGS. 1 and 2, and these elements are labeled with the same identifiers. The ecommerce platform 204 is part of an e-commerce infrastructure 304 that includes an ecommerce platform adapter 306 (e.g., an application programming interface “API”) for communicating with the collaboration platform 202, which is part of a collaboration infrastructure 302. The customer 110A may be browsing products available on the ecommerce platform 204 via a user interface “UI” such as an “Ecommerce platform UI” displayed on the “Web browser” of client device 115A, as shown in FIG. 2. The collaboration platform 202 can determine, based on accessed session and customer data as explained above or based on a request from customer 110A, that the customer 110A would like to collaborate with a sales agent 110B. The collaboration platform 202 may transmit a first collaboration widget 308 to the client device 115A and a second collaboration widget 308 to the client device 115B of sales agent 110B if the client device 115B does not already have the collaboration widget 308 installed. The sales agent 110B may receive a notice (e.g., together with the collaboration widget 308) that customer 110A wants to collaborate in an “Agent backoffice UI” displayed on the “Web browser” of client device 115B shown in FIG. 2. The two collaboration widgets 308 are configured to interface with the “Ecommerce platform UI” and the “Agent backoffice UI” respectively, and to communicate with the ecommerce platform adapter 306 and the collaboration platform 202, e.g., over network 105.

The collaboration platform 202 may generate the collaboration widgets 308 to transmit to the customer device 115A or agent device 115B based on detected capabilities of the customer device 115A or agent device 115B (e.g., capabilities of their respective web browsers). The collaboration widgets 308 provide any missing capabilities to the customer device 115A or agent device 115B in order to enable a visual communication with the collaboration platform 202 without requiring either the customer device 115A or agent device 115B to have any other executable files pre-installed. After the customer device 115A and the agent device 115B have received the collaboration widget 308, the customer device 115A and the agent device 115B can access the collaboration user interface 208 generated by the collaboration platform 202 so that a link is established between the customer device 115A, the collaboration platform 202, and the agent device 115B for shared viewing and manipulation of files in the collaboration user interface 208. The collaboration user interface 208 is displayed on the web browsers of both the customer device 115A and the agent device 115B, enabling a shared view of media files. In this way, both the customer 110A and the agent 110B can view/manipulate the same content displayed on their respective browsers.

Both the customer 110A and the agent 110B can manipulate the shared view in the collaboration user interface 208. For example, the agent 110B can change the shared view in the collaboration user interface 208 from media content at one universal resource locator (“URL”) source location to content at a second URL source location. Any such changes are communicated to the collaboration platform 202 via the collaboration widget 308; the collaboration platform 202 subsequently transmits the changes to the collaboration widget 308 on the customer device 115A, which then implements the change in the collaboration user interface 208 displayed on the customer device 115A. The collaboration widget 308 on the customer device 115A may also notify the collaboration platform 202 that the change has been implemented on the customer device 115A. Of course, this process can be performed bi-directionally, so that the customer device 115A can change the shared view in the collaboration user interface 208 and cause a conforming change on the agent device 115B via the collaboration widget 308 and the collaboration platform 202.

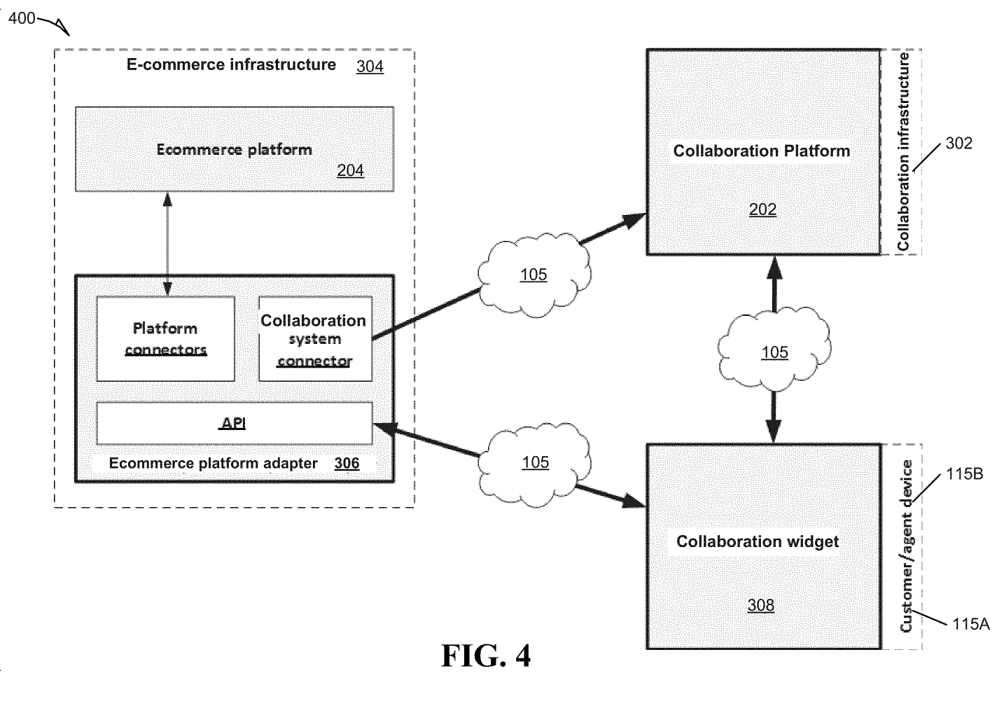

FIG. 4 is a block diagram depicting a network system 400 having a client-server architecture, according to one embodiment, configured to provide a collaboration user interface for the shared viewing and manipulating of media files. The elements in FIG. 4 include some elements from FIGS. 1-3, and these elements are labeled with the same identifiers. The ecommerce platform adapter 306 includes an “API” for communicating with the collaboration widgets 308 and connectors (e.g., software/hardware for effecting/regulating interactions between components) for communicating with the ecommerce platform 204 or other platforms (e.g., the “Platform connectors”) and the collaboration platform 202 (e.g., the “Collaboration system connector”). The collaboration platform 202 may identify the sales agent 110B (for collaboration with customer 110A) based on sales agent information obtained from the ecommerce platform 204 via the collaboration system connector. The sales agent information can indicate, for example, an association between the sales agent 110B and the ecommerce platform 204 (e.g., or an association with a particular e-commerce website of the ecommerce platform 204), an association between the sales agent 110B and the metadata associated with a data file (e.g., a manufacturer associated with the data file), or sales agent information can indicate previous collaborations between the customer 110A and the sales agent 110B or a previous collaboration between the customer 110A and a virtual (e.g., non-human artificial intelligence) sales agent. This sales agent information may already be available to the collaboration platform 202 by being previously stored as “Analytics” in the collaboration platform 202. Furthermore, the sales agent information stored as “Analytics” can include a selected preference of the sales agent 110B, information associated with an employer of the sales agent 110B, or information associated with data files previously viewed by the sales agent 110B in a collaboration user interface 208 provided via the collaboration platform 202.

The above-noted sales agent information can also be used to identify the one or more sources of data files (e.g., from external resources 206, or from the “Uploaded custom resources” and “Resource catalog” of the collaboration platform 202) that may be presented to the customer 110A and the sales agent 110B, such as the first data file, for shared viewing/manipulating in the collaboration user interface 208. For example, sources including products sold by an employer of the sales agent 110B might be selected. Furthermore, a customer relationship management (CRM) system or enterprise resource planning (ERP) of an employer of the sales agent 110B may be selected as a source of data files for shared viewing/manipulating in a collaboration user interface 208 by customer 110A and the sales agent 110B.

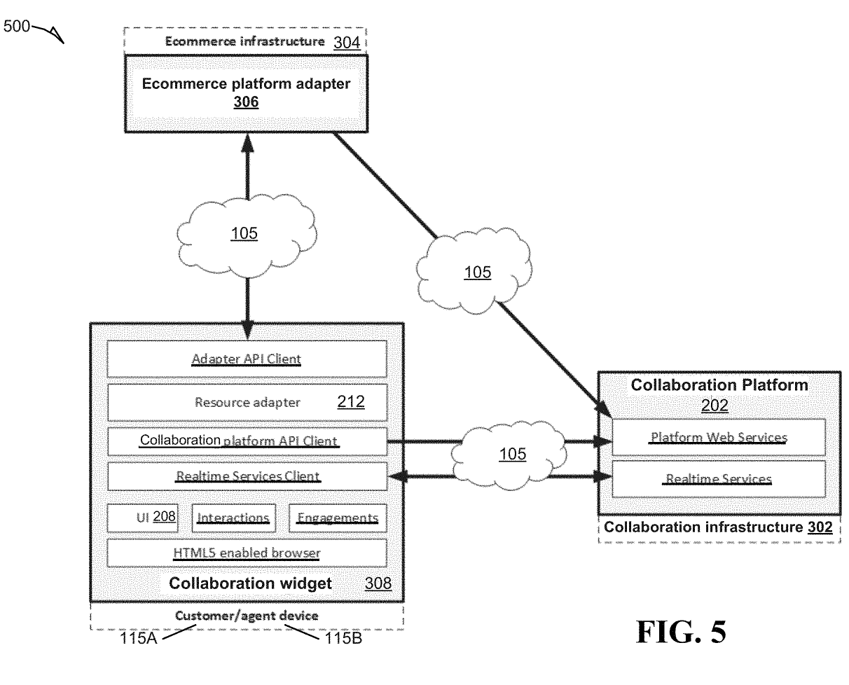

FIG. 5 is a block diagram depicting a network system 500 having a client-server architecture, according to one embodiment, configured to provide a collaboration user interface for the shared viewing and manipulating of media files. The elements in FIG. 5 include some elements from FIGS. 1-4, and these elements are labeled with the same identifiers. The collaboration widget 308 includes an “Adapter API client” for communicating with the ecommerce platform 204 via the “API” of the ecommerce platform adapter 306. The collaboration widget 308 also includes a “Collaboration platform API client” and a “Realtime Service Client” for communicating with “Platform Web Services” and “Realtime Services” of the collaboration platform 202. Additionally, the collaboration widget 308 includes “Interactions” and “Engagements” modules to register activities of the customer 110A and the sales agent 110B and provide the registered information to the “Analytics” of the collaboration platform 202. The information collected by the “Interactions” and “Engagements” modules is also used to provide status indicators, as explained above, to the sales agent 110B via the collaboration user interface 208. The collaboration widget 308 also provides the client devices 115A and 115B with access to the collaboration user interface (“UI”) 208 by providing any components that are needed and not already available to the client devices 115A and 115B, such as, for example, a browser upgrade for the client devices 115A, 115B (e.g., hypertext markup language “HTML” version upgrade) and the resource adapter 212 for converting data files to a format that is easily viewed/manipulated within the collaboration UI 208.

The collaboration user interface 208 makes use of the resource adapter 212 in order to provide an arbitrary list of user-selectable links to individual data files (e.g., an image or video file) or links to searchable collections of data files because the resource adapter 212 allows the viewing/manipulating of data files to not be limited by the capabilities of the respective client devices 115A and 115B. For example, the collaboration widget 308 may dynamically load, into resource adapter 212, an adapter library (e.g., from the collaboration platform 202) for adapting at least one data type (e.g., an image or video file format) of at least one data file associated with the user-selectable links. Then the collaboration widget 308 can, based on a selection of a link by the customer 110A or sales agent 110B, provide options (e.g., in the collaboration user interface 208) for viewing and manipulating a data file associated with the selected link or a browser option for searching a collection of data files associated with the selected link.

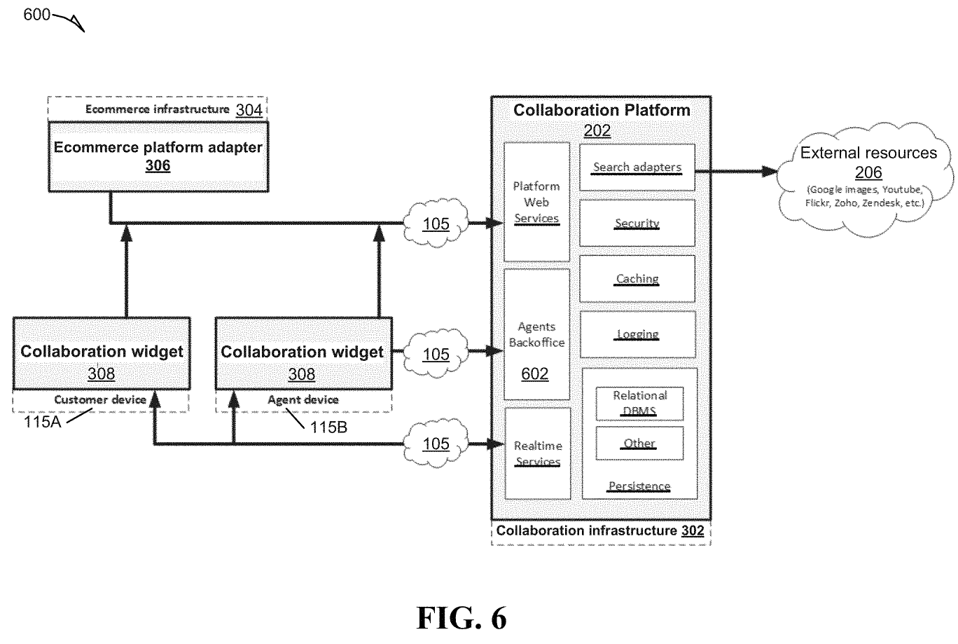

FIG. 6 is a block diagram depicting a network system 600 having a client-server architecture, according to one embodiment, configured to provide a collaboration user interface for the shared viewing and manipulating of media files. The elements in FIG. 6 include some elements from FIGS. 1-5, and these elements are labeled with the same identifiers. The collaboration platform 202 provides “Platform Web Services” and “Realtime Services” and, in an embodiment, may also include the back office of sales agent 110B, e.g., agent's backoffice 602. The collaboration platform 202 also includes “Search adapters” for searching external resources 206 such as images, documents, videos, etc., found on the internet. The collaboration platform 202 also includes a “Persistence” module for storing data (e.g., “Analytics”) including a relational database management system “Relational DBMS” and possibly other data storage systems. Additionally, the collaboration platform 202 includes “Security”, “Caching”, and “Logging” modules to secure and facilitate data transfers and to log any such data transactions, e.g., based on the activities of the customer 110A and the sales agent 110B.

The collaboration platform 202 can provide the options for viewing and manipulating data files, including options for editing a data file. The collaboration widget 308 can receive an edit to a first data file from the customer 110A or sales agent 110B via the collaboration user interface 208 and apply the edit to the view of the first data file. The collaboration widget 308 can then transmit a copy of the edited first data file to the collaboration platform 202 (e.g., based on being polled by collaboration platform 202) which can pass the edited first data file to the client device 115A or 115B for viewing in the collaboration user interface 208 based on the client device 115A or 115B not having a copy of the edited first data file. Furthermore, the edit to the first data file may itself be edited by the customer 110A or sales agent 110B after viewing the edited first data file. For example, the collaboration widget 308 can receive a revision of the edit to the first data file from the customer 110A or sales agent 110B via the collaboration user interface 208 and apply the revision to the edit of the view of the first data file. The collaboration widget 308 can then transmit a copy of the revised edited first data file to the collaboration platform 202 (e.g., based on the changed view of the first data file) which can pass the revised edited first data file to the client device 115A or 115B for viewing in the collaboration user interface 208 based on the client device 115A or 115B not having a copy of the revised edited first data file.

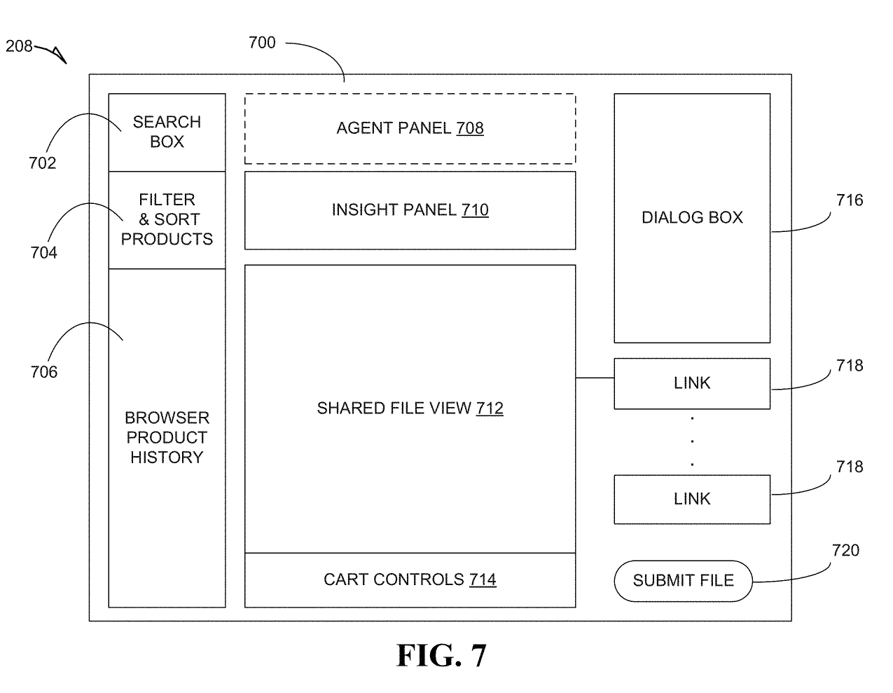

The collaboration platform 202 can also provide the options for transmitting and receiving messages between the customer 110A and the sales agent 110B and viewing the messages in a dialog box (shown in FIG. 7) of the collaboration user interface 208 via a message transmission module that forms part of the “Realtime services”. For example, the collaboration widget 308 can receive a message regarding a selected link from the customer 110A or the sales agent 110B via the collaboration user interface 208 and then transmit the message to the client device 115A or 115B for viewing in the collaboration user interface 208 based on the client device 115A or 115B not having a copy of the message.

### User Interface

FIG. 7 is a display diagram illustrating an embodiment of the collaboration user interface 208 provided to a customer 110A or sales agent 110B via a client device 115A or 115B. As shown in FIG. 7, a display 700 of client device 115A or 115B may show the elements of the collaboration user interface 208 including a shared file view 712 of a selected data file for viewing and manipulating. The customer 110A and sales agent 110B can jointly zoom, pan, point, and scroll through images in the shared file view 712 to uncover details that might otherwise be missed. Furthermore, the customer 110A and sales agent 110B can also edit the images in the shared file view 712 (as explained above) via touch screen, keyboard, mouse or other appropriate controls. The browsing session of customer 110A at an e-commerce website (e.g., of ecommerce platform 204), which led to the collaboration with sales agent 110B, can provide a browser product history 706 which shows items from the “Product catalog” of ecommerce platform 204. The items shown in the browser product history 706 may be selected for viewing and/or manipulating in the shared file view 712. Furthermore, the items shown in the browser product history 706 may be filtered or sorted using the filter & sort products 704 element and may be searched using the search box 702 of collaboration user interface 208. The collaboration user interface 208 may access a search engine of ecommerce platform 204 (via ecommerce platform adapter 306) to conduct a search according to input from customer 110A or sales agent 110B in search box 702.

The elements of collaboration user interface 208 may also include cart controls 714, which can allow customer 110A (or even sales agent 110B) to easily add products to a product shopping cart or product wish list of customer 110A at the e-commerce website of ecommerce platform 204 (via ecommerce platform adapter 306) without having to exit the collaboration user interface 208. The cart controls 714 can even allow for a checkout including a payment transaction (e.g., credit card payment) at the e-commerce website of ecommerce platform 204 (via ecommerce platform adapter 306) without having to exit the collaboration user interface 208. Furthermore, an insight panel 710 of the collaboration user interface 208 can allow access (e.g., viewing) to the shopping cart or wish list of customer 110A at the e-commerce website of ecommerce platform 204 (via ecommerce platform adapter 306) without having to exit the collaboration user interface 208.

The elements of collaboration user interface 208 may also include an arbitrary list of user selectable links 718 to individual data files (e.g., an image or video file) or to searchable collections of data files. Then, based on a selection of a link 718 by the customer 110A or sales agent 110B, collaboration user interface 208 can provide options (e.g., in the shared file view 712) for viewing and manipulating a data file associated with the selected link 718 or a browser option (e.g., in the shared file view 712 or the browser product history 706) for searching a collection of data files associated with the selected link 718. Additionally a submit file 720 element of the collaboration user interface 208 can be used by the customer 110A or sales agent 110B to upload data files to the “Uploaded custom resources” or “Resource catalog” of the collaboration platform 202 respectively for viewing and/or manipulating in the shared file view 712. In this way the customer 110A or sales agent 110B can explain something, with an image or a video, that would be more difficult to explain with only words.

The elements of collaboration user interface 208 may also include a dialog box 716 that provides options for transmitting, receiving and viewing messages between the customer 110A and the sales agent 110B (e.g., via the message transmission module of collaboration platform 202). In this way the customer 110A or sales agent 110B can engage in meaningful dialog, including getting immediate answers to questions, regarding a file in shared file view 712.

The elements of collaboration user interface 208 may also include an agent panel 708 that is only viewable by sales agent 110B via the collaboration widget 308 (e.g., a “sales agent” widget) provided to client device 115B of sales agent 110B. The agent panel 708 can provide options for managing interactions between sales agents, such as smoothly transferring a collaboration session (e.g., with customer 110A) to another agent or communicating with a co-worker to get help with respect to a product that the sales agent 110B is not familiar with. In this regard, the agent panel 708 can provide the sales agent 110B with a suggestion of another sales agent (e.g., based on agent, customer and product data) for handling a pending collaboration session. The agent panel 708 can also provide an engagement toolbox for capturing contact information of customer 110A (e.g., e-mail to send forms or phone number to connect by voice) or accessing a sales agent library of frequently used phrases that have been found to be successful in helping customers to make a purchase. The agent panel 708 can also provide a session manager for easily flipping between multiple collaboration sessions and prioritizing the customers that need attention first, for example with a color-coded system for ranking open collaboration sessions. The sessions could be ranked according to various factors such as length of session, identity of customer or value of products.

### Methods

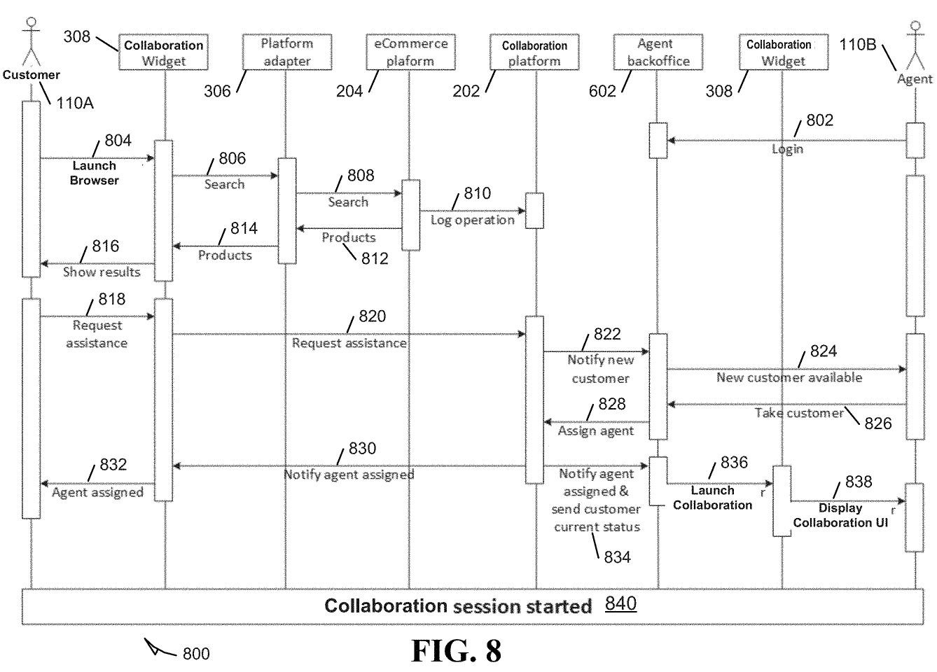

FIG. 8 is a ladder diagram illustrating a method 800, in accordance with an example embodiment, for connecting a customer with a sales agent for the shared viewing and manipulating of media files. The elements in FIG. 8 include some elements from FIGS. 1-6, and these elements are labeled with the same identifiers. Initially a pool of sales agents is established at one or more agent backoffice 602 by having available agents (e.g., sales agent 110B) log in to their respective backoffice 602 at operation 802. At operation 804, customer 110A can launch a browser session (via client device 115A) at an e-commerce website of ecommerce platform 204. The session may be established directly from the browser to the ecommerce platform 204 or, if the collaboration widget 308 is already installed on client device 115A, then the session is established via the collaboration widget 308 and the ecommerce platform adapter 306. At operation 806, customer 110A can search the ecommerce platform 204 for products the customer 110A may be interested in. Again, if the collaboration widget 308 is already installed on client device 115A, then the search is performed via the collaboration widget 308 and the ecommerce platform adapter 306 at operation 808. At operation 810 the product searches of customer 110A are logged (e.g., via the ecommerce platform adapter 306) at collaboration platform 202 and stored as “Analytics” data as noted above. At operation 812, the ecommerce platform 204 returns the product search results to client device 115A (via the ecommerce platform adapter 306 and collaboration widget 308 at operation 814 if needed), and at operation 816 the results of the searches are shown to customer 110A, e.g., via a display of client device 115A.

At operation 818, the customer 110A can request the assistance of a sales agent (or the desire for assistance can be determined from other data regarding customer 110A as explained above) at collaboration platform 202. If the collaboration widget 308 is already installed on client device 115A, then the request is performed via the collaboration widget 308. Otherwise, at operation 820, the request is sent to collaboration platform 202, which then transmits a collaboration widget 308 to client device 115A based on detected capabilities of client device 115A and detected capabilities of the “web browser” of client device 115A. At operation 822, the collaboration platform 202 notifies agent backoffice 602 that a new customer 110A has requested assistance. The customer 110A may be added to a queue of customers awaiting assistance at either or both of the collaboration platform 202 and the agent backoffice 602. At operation 824, a sales agent 110B may be selected (based on the login at operation 802) to assist customer 110A (the selection process was explained above), and the sales agent 110B is notified that a customer (e.g., customer 110A) has requested assistance. At operation 826, the sales agent 110B can agree to assist the customer 110A, and at operation 828 the agent backoffice 602 can inform the collaboration platform 202 that sales agent 110B has been assigned to help customer 110A.

At operations 830 and 832, the collaboration platform 202 notifies the customer 110A, via the collaboration widget 308 installed on client device 115A at operation 804, that sales agent 110B has been assigned to assist in the customer 110A in evaluating the products that have been browsed by the customer 110A or other similar or related products. At operation 834, the sales agent 110B is notified about the customer 110A (e.g., provided with information regarding customer 110A) including a notification regarding the status of customer 110A, e.g., based on an activity of the customer 110A such as adding a product to a shopping cart. At operation 836, the agent backoffice 602 launches a collaboration (e.g., collaboration user interface 208 provided by collaboration platform 202) via the collaboration widget 308 installed on client device 115B of sales agent 110B. At operation 838 the collaboration widget 308 installed on client device 115B provides sales agent 110B with access to the collaboration user interface 208 via a display of client device 115B of sales agent 110B. At operation 840 the collaboration session between sales agent 110B and customer 110A is started, and the collaboration widget 308 installed on client device 115A provides customer 110A with access to the collaboration user interface 208 via a display of client device 115A.

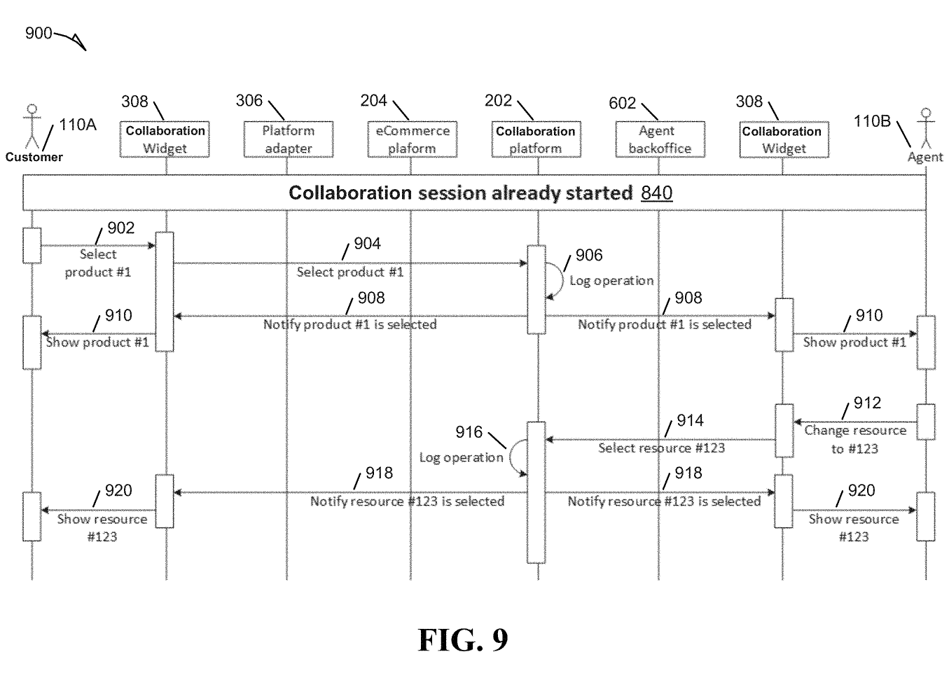

FIG. 9 is a ladder diagram illustrating a method 900, in accordance with an example embodiment, for initially selecting and then changing the files for shared viewing and manipulating in a collaboration user interface. The elements in FIG. 9 include some elements from FIGS. 1-6, and these elements are labeled with the same identifiers. At operation 902 (which follows operation 840 from FIG. 8), an initial data file (e.g., associated with a product) is selected for viewing and manipulating in collaboration user interface 208 via collaboration widget 308 installed on client device 115A at operation 904. The selection can be made directly by customer 110A by selecting a link 718 or a browsed product form browser product history 706 in collaboration user interface 208, or it can be made by collaboration platform 202 based on information about customer 110A including information regarding the browsing session of customer 110A at the e-commerce website of ecommerce platform 204. At operation 906, the first data file selection is logged at collaboration platform 202 and may be stored as further “Analytics” data as noted above. At operation 908, the collaboration platform 202 notifies the respective collaboration widgets 308 stored on client devices 115A and 115B that a first data file has been selected for shared viewing and manipulating in a collaboration user interface 208. At operation 910 the first data file is shown to customer 110A and sales agent 110B, e.g., via shared file view 712 of collaboration user interface 208 on a display of client device 115A and client device 115B.

At operation 912, a next data file (e.g., associated with the same or a different product) is selected for viewing and manipulating in collaboration user interface 208. The selection can be made by sales agent 110B (or alternatively by customer 110A) in collaboration user interface 208 (via collaboration widget 308 installed on client device 115B), for example, by selecting a link 718 of collaboration user interface 208 to access a resource #123 from an arbitrary list of resources. At operation 914 the collaboration widget 308 installed on client device 115B notifies collaboration platform 202 that the next data file has been selected for viewing/manipulating in the collaboration user interface 208. At operation 916, the next data file selection is logged at collaboration platform 202 and may be stored as further “Analytics” data as noted above. At operation 918, the collaboration platform 202 notifies the respective collaboration widgets 308 stored on client devices 115A and 115B that a next data file has been selected for shared viewing and manipulating in a collaboration user interface 208. At operation 920 the next data file is shown to customer 110A and sales agent 110B, e.g., via shared file view 712 of collaboration user interface 208 on a display of client device 115A and client device 115B.

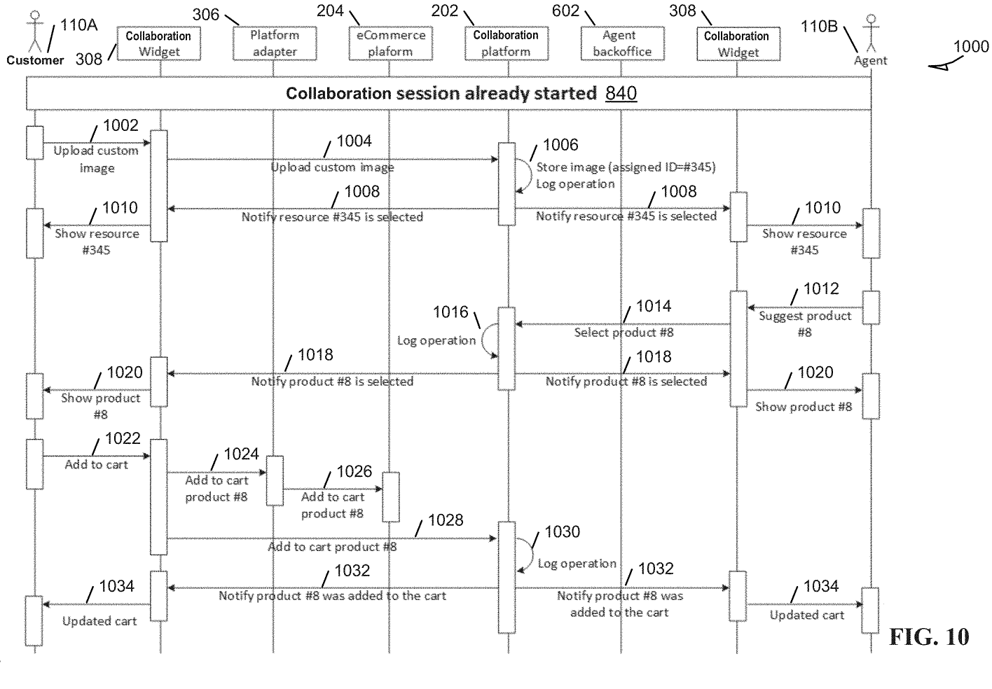

FIG. 10 is a ladder diagram illustrating a method 1000, in accordance with an example embodiment, for selecting a product for purchase based on uploading a custom file for shared viewing and manipulating in a collaboration user interface. The elements in FIG. 10 include some elements from FIGS. 1-6, and these elements are labeled with the same identifiers. At operation 1002 (which follows operation 840 from FIG. 8), a custom data file (e.g., associated with a product) is uploaded for viewing and manipulating in collaboration user interface 208 via collaboration widget 308 installed on client device 115A at operation 1004. The upload can be made directly by customer 110A (or alternatively by sales agent 110B) by selecting a submit file 720 in collaboration user interface 208, or it can be made by selecting a link 718 of collaboration user interface 208 to access the “Uploaded custom resources” or “Resource catalog” of collaboration platform 202. At operation 1006, the custom data file upload is logged at collaboration platform 202 and may be stored as further “Uploaded custom resources” or “Resource catalog” data at the collaboration platform 202 and assigned, for example, an identification (ID) #345. At operation 1008, the collaboration platform 202 notifies the respective collaboration widgets 308 stored on client devices 115A and 115B that a custom data file has been selected for shared viewing and manipulating in a collaboration user interface 208. At operation 1010 the custom data file is shown to customer 110A and sales agent 110B, e.g., via shared file view 712 of collaboration user interface 208 on a display of client device 115A and client device 115B.

At operation 1012, a suggested data file (e.g., associated with the same or a different product) is selected for viewing and manipulating in collaboration user interface 208. The selection can be made by sales agent 110B (or alternatively by customer 110A) in collaboration user interface 208 (via collaboration widget 308 installed on client device 115B), for example, by selecting a link 718 of collaboration user interface 208 to access a product #8 from an arbitrary list of resources. At operation 1014 the collaboration widget 308 installed on client device 115B notifies collaboration platform 202 that the suggested data file has been selected for viewing/manipulating in the collaboration user interface 208. At operation 1016, the suggested data file selection is logged at collaboration platform 202 and may be stored as further “Analytics” data as noted above. At operation 1018, the collaboration platform 202 notifies the respective collaboration widgets 308 stored on client devices 115A and 115B that a suggested data file has been selected for shared viewing and manipulating in a collaboration user interface 208. At operation 1020, the suggested data file is shown to customer 110A and sales agent 110B, e.g., via shared file view 712 of collaboration user interface 208 on a display of client device 115A and client device 115B

At operation 1022, product #8 (associated with the suggested data file) is added to a shopping cart at ecommerce platform 204 via the collaboration user interface 208. The addition to the shopping cart can be made directly by customer 110A (or alternatively by sales agent 110B) by using cart controls 714 in collaboration user interface 208 (via collaboration widget 308 installed on client device 115A at operation 1024 and ecommerce platform adapter 306 at operation 1026). At operation 1028, the collaboration platform 202 is notified via the collaboration widget 308 installed on client device 115A of customer 110A that product #8 has been added to a shopping cart at ecommerce platform 204. At operation 1030, the addition of product #8 to the shopping cart may be logged at collaboration platform 202 and may be stored as further “Analytics” data as noted above and used as the basis for a customer status indicator in the agent panel 708 of collaboration user interface 208. At operation 1032, the collaboration platform 202 notifies the respective collaboration widgets 308 stored on client devices 115A and 115B that product #8 has been added to a shopping cart. At operation 1034, the update to the shopping cart is shown to customer 110A and sales agent 110B, e.g., via a notification in shared file view 712 (or in dialog box 716) of collaboration user interface 208 on a display of client device 115A and client device 115B.

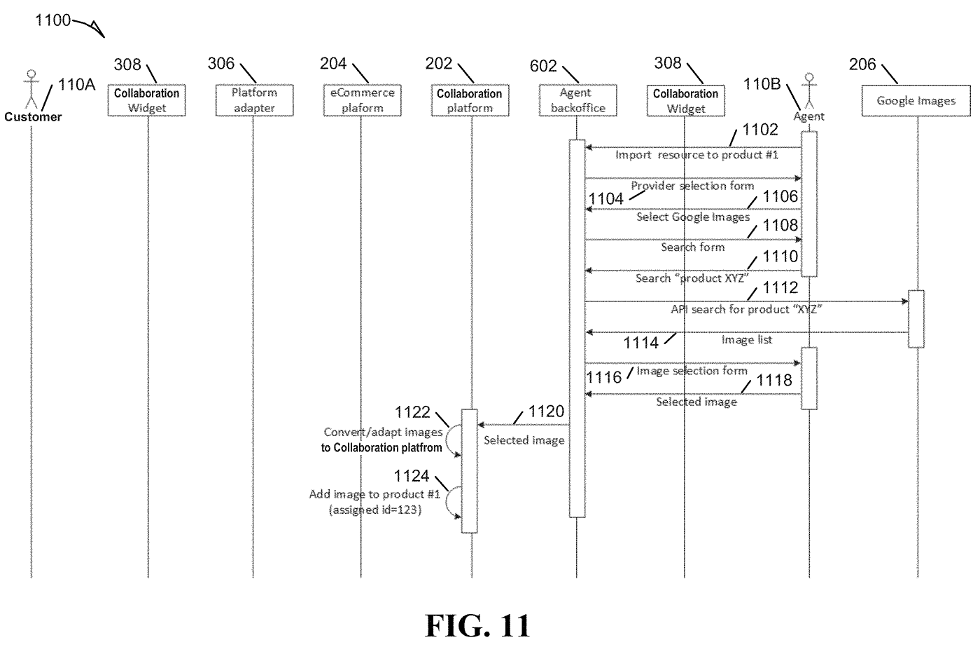

FIG. 11 is a ladder diagram illustrating a method 1100, in accordance with an example embodiment, for searching arbitrary sources for media files and converting/adapting a selected file for shared viewing and manipulating in a collaboration user interface. At operation 1102, the sales agent 110B can, via the agent backoffice 602 (or the collaboration platform 202), import a custom media file (product #1) or select one form the “Resource catalog” of collaboration platform 202 to serve as the basis (or part of the basis) for a search of external resources to discover additional media files for shared viewing and manipulating in the collaboration user interface 208. At operation 1104, agent backoffice 602 (or the collaboration platform 202) can provide the sales agent 110B with a form for selecting from a list of external sources that have been determined to include media files of interest based on the import of product #1 at operation 1102. At operation 1106, the sales agent 110B can select, from the provided form, a source of media files for further searching, e.g., “Google images” in the present example. At operation 1108, agent backoffice 602 (or the collaboration platform 202) can provide the sales agent 110B with a form for entering search terms to serve as the basis for a search of the selected source of media files. At operation 1110, the sales agent 110B can enter the desired terms, using the provided form, for a search of the selected source of media files, e.g., “product XYZ” in the present example.

At operation 1112, the agent backoffice 602 (or the collaboration platform 202, since the agent backoffice 602 may form part of the collaboration platform 202, as explained with regard to FIG. 6 above) can perform a search for product XYZ in the selected source of media files, using the “Search adapters” of collaboration platform 202 to interface with the API of the selected media file source if necessary. At operation 1114, the agent backoffice 602 (or the collaboration platform 202) can receive a list of media files (e.g., images or videos) from the selected source of media files based on the search. At operation 1116, agent backoffice 602 (or the collaboration platform 202) can provide the sales agent 110B with a form for selecting from a list of media files that have been returned by the search of product XYZ at operation 1112. At operation 1118, the sales agent 110B can select, from the provided form, a media file for shared viewing and manipulating in the collaboration user interface 208. At operation 1120 the agent backoffice 602 can notify the collaboration platform 202 about the selected media file, if necessary, since the agent backoffice 602 may form part of the collaboration platform 202. At operation 1122 the collaboration platform 202 may convert (e.g., change image file format) or adapt (change image dimensions) the selected media file (e.g., using resource adapter 212 for viewing and manipulating in the collaboration user interface 208). At operation 1124, the collaboration platform 202 may associate the selected media file with product #1 and assign it an ID #123 for later reference.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via the network 105 (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product (e.g., a computer program tangibly embodied in an information carrier, e.g., in a machine-readable medium for execution by, or to control the operation of, data processing apparatus, e.g., a programmable processor, a computer, or multiple computers).

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed in various example embodiments.

### Example Computer System

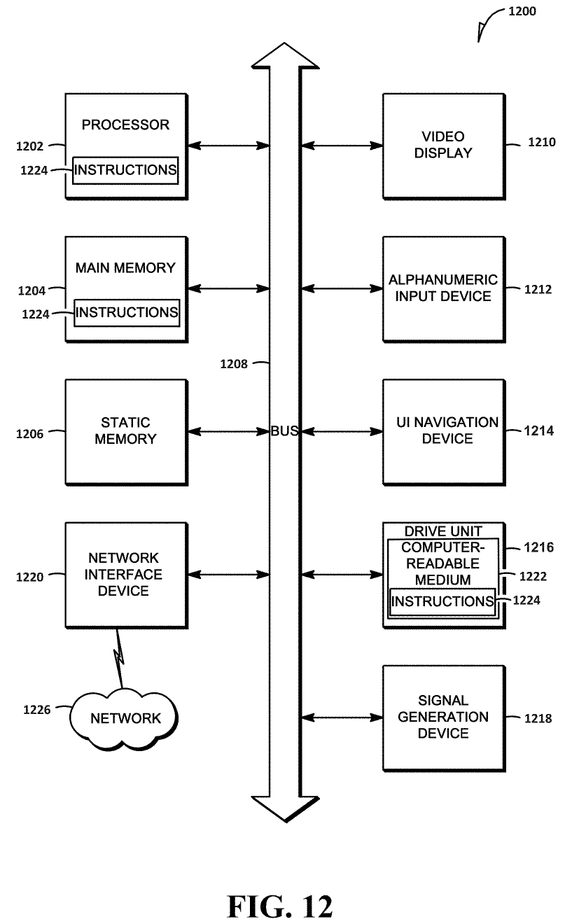

FIG. 12 shows a diagrammatic representation of a machine in the example form of a machine or computer system 1200 within which a set of instructions 1224 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions 1224 (sequential or otherwise) that specify actions to be taken by that machine. Further, while only a single machine is illustrated, the term “machine” shall also be taken to include any collection of machines that individually or jointly execute a set (or multiple sets) of instructions 1224 to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a UI navigation device 1214 (e.g., a mouse), a drive unit 1216, a signal generation device 1218 (e.g., a speaker), and a network interface device 1220.

The drive unit 1216 includes a computer-readable medium 1222 on which is stored one or more sets of data structures and instructions 1224 (e.g., software) embodying or used by any one or more of the methodologies or functions described herein. The instructions 1224 may also reside, completely or at least partially, within the main memory 1204 or within the processor 1202 during execution thereof by the computer system 1200, with the main memory 1204 and the processor 1202 also constituting machine-readable media.

The instructions 1224 may further be transmitted or received over a network 1226 via the network interface device 1220 utilizing any one of a number of well-known transfer protocols (e.g., HTTP).

While the computer-readable medium 1222 is shown in an example embodiment to be a single medium, the term “computer-readable medium” should be taken to include a single medium or multiple media (e.g., a centralized or distributed database, and/or associated caches and servers) that store the one or more sets of instructions 1224. The term “computer-readable medium” shall also be taken to include any medium that is capable of storing, encoding, or carrying a set of instructions 1224 for execution by the machine that cause the machine to perform any one or more of the methodologies of the present disclosure, or that is capable of storing, encoding, or carrying data structures used by or associated with such a set of instructions 1224. The term “computer-readable medium” shall, accordingly, be taken to include, but not be limited to, solid-state memories, optical media, and magnetic media.

Furthermore, the machine-readable medium is non-transitory in that it does not embody a propagating signal. However, labeling the tangible machine-readable medium “non-transitory” should not be construed to mean that the medium is incapable of movement—the medium should be considered as being transportable from one physical location to another. Additionally, since the machine-readable medium is tangible, the medium may be considered to be a machine-readable device.

### Example Mobile Device

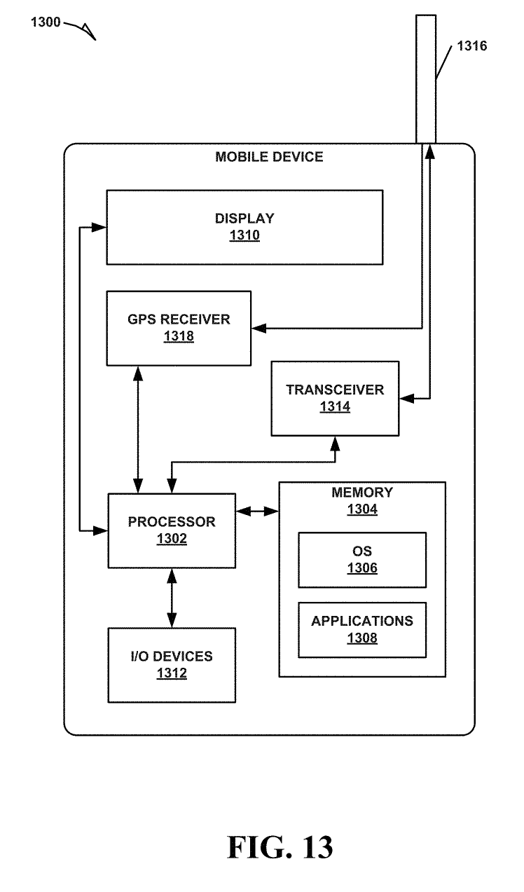

FIG. 13 is a block diagram illustrating a mobile device 1300, according to an example embodiment. The mobile device 1300 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or another type of memory, is typically accessible to the processor 1302. The memory 1304 may be adapted to store an operating system (OS) 1306, as well as applications 1308, such as a mobile location-enabled application that may provide location-based services (LBSs) to a user. The processor 1302 may be coupled, either directly or via appropriate imaging hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 uses the antenna 1316 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

Such embodiments of the inventive subject matter may be referred to herein, individually or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
at least one server configured to communicate with two or more client devices; and
a collaboration module implemented by the at least one server and configured to:
access session data from a browsing session of a first user of a first client device, of the two or more client devices, at a website of an enterprise;
access, from the enterprise, first user information associated with the first user;
determine, based on the session data and the first user information, that the first user would like to collaborate with a second user of a second client device of the two or more client devices;
retrieve a first data file from the enterprise based on the session data and the first user information;
determine a data type of the first data file;
access, from the enterprise, metadata associated with the first data file;
identify one or more sources of data files based on at least one of the first data file, the data type and the metadata;
generate a collaboration user interface providing: options for viewing and manipulating the first data file, and a user-selectable list of the one or more sources of data files;
transmit a first collaboration widget to the first device and a second collaboration widget to the second device; and
provide the first and second client devices with access to the collaboration user interface using the first and second collaboration widgets respectively.

2. The system of claim 1, wherein the collaboration module is further configured to determine that the first user would like to collaborate with the second user based on a request from the first user.

3. The system of claim 2, wherein the website comprises an e-commerce website and the first data file comprises an image or a video that depicts a product available for purchase at the e-commerce website.

4. The system of claim 3, wherein the collaboration module is further configured to identify the second user based on second user information accessed from the enterprise, the second user information indicating an association between the second user and the e-commerce website, indicating an association between the second user and the metadata associated with the first data file, or indicating previous collaborations between the first user and the second user.

5. The system of claim 4, wherein the second user is a sales agent and the collaboration module is further configured to identify the one or more sources of data files based on the second user information.

6. The system of claim 5, wherein the second user information comprises: a selected preference of the second user, information associated with an employer of the second user, or information associated with data files previously viewed by the second user in the collaboration user interface.

7. The system of claim 5, wherein the collaboration module is further configured to display, in the collaboration user interface on the second device, a status indicator for the first user based on an activity of the first user in a specified context.

8. The system of claim 7, wherein the activity is adding a product to a shopping cart or purchasing a product in the context of the e-commerce website, or minimizing or exiting the collaboration user interface in any context.

9. The system of claim 1, wherein the user-selectable list comprises a list of links to individual data files or links to searchable collections of data files, and the collaboration module is further configured to:
receive a selection of a link from the first or second user via the collaboration user interface; and
provide options for viewing and manipulating a second data file associated with the selected link or a browser option for searching a collection of data files associated with the selected link.

10. The system of claim 9, wherein the collaboration module is further configured to use the first or second collaboration widget to dynamically load an adapter library for adapting at least one data type of at least one data file associated with the selected link for viewing on the first or second client devices respectively.

11. The system of claim 9, wherein the user-selectable list comprises a list of links to individual data files in a memory of the first or second client device or links to searchable collections of data files in a memory of the first or second client device.

12. The system of claim 1, wherein the options for viewing and manipulating the first data file comprise options for editing the first data file, and the collaboration module is further configured to:
receive an edit to the first data file from the first or second user via the collaboration user interface;
apply the edit to the first data file; and
transmit a copy of the edited first data file to the first or second client device for viewing in the collaboration user interface based on the first or second client device not already having a copy of the edited first data file.

13. The system of claim 12, wherein the collaboration module is further configured to:
receive a revision of the edit to the first data file from the first or second user via the collaboration user interface;
apply the revised edit to the first data file; and
transmit a copy of the revised edited first data file to the first or second client device for viewing in the collaboration user interface based on the first or second client device not already having a copy of the revised edited first data file.

14. The system of claim 9, further comprising a message transmission module implemented by the at least one server and configured to:
receive a message regarding the selected link from the first or second user via the collaboration user interface;
transmit the message to the first or second client device based on the first or second client device not already having a copy of the message; and
display the message in the collaboration user interface.

15. A method implemented by at least one server and comprising:
accessing session data from a browsing session of a first user of a first client device at a website of an enterprise;
accessing, from the enterprise, first user information associated with the first user;
determining, based on the session data and the first user information, that the first user would like to collaborate with a second user of a second client device;
retrieving a first data file from the enterprise based on the session data and the first user information;
determining a data type of the first data file;
accessing, from the enterprise, metadata associated with the first data file;
identifying one or more sources of data files based on at least one of the first data file, the data type and the metadata;
generating a collaboration user interface providing: options for viewing and manipulating the first data file, and a user-selectable list of the one or more sources of data files;
transmitting a first collaboration widget to the first device and a second collaboration widget to the second device; and
providing the first and second client devices with access to the collaboration user interface using the first and second collaboration widgets respectively.

16. The method of claim 15, wherein:
the website comprises an e-commerce website;
the first data file comprises an image or a video that depicts a product available for purchase at the e-commerce website;
the second user is a sales agent associated with the e-commerce website; and
the one or more sources of data files are identified based on sales agent information accessed from the enterprise.

17. The method of claim 15, wherein the user-selectable list comprises a list of links to individual data files or links to searchable collections of data files, and the method further comprises:
receiving a selection of a link from the first or second user via the collaboration user interface; and
providing options for viewing and manipulating a second data file associated with the selected link or a browser option for searching a collection of data files associated with the selected link.

18. The method of claim 15, wherein the options for viewing and manipulating the first data file comprise options for editing the first data file, and the method further comprises:
receiving an edit to the first data file from the first or second user via the collaboration user interface;
applying the edit to the first data file; and
transmitting a copy of the edited first data file to the first or second client device for viewing in the collaboration user interface based on the first or second client device not already having a copy of the edited first data file.

19. The method of claim 18, further comprising:
receiving a revision of the edit to the first data file from the first or second user via the collaboration user interface;
applying the revised edit to the first data file; and
transmitting a copy of the revised edited first data file to the first or second client device for viewing in the collaboration user interface based on the first or second client device not already having a copy of the revised edited first data file.

20. A non-transitory computer-readable medium storing program code which, when executed by at least one processor of a server, is operative to cause the server to perform the steps of:
accessing session data from a browsing session of a first user of a first client device at a website of an enterprise;
accessing, from the enterprise, first user information associated with the first user;
determining, based on the session data and the first user information, that the first user would like to collaborate with a second user of a second client device;
retrieving a first data file from the enterprise based on the session data and the first user information;
determining a data type of the first data file;
accessing, from the enterprise, metadata associated with the first data file;
identifying one or more sources of data files based on at least one of the first data file, the data type and the metadata;
generating a collaboration user interface providing: options for viewing and manipulating the first data file, and a user-selectable list of the one or more sources of data files;
transmitting a first collaboration widget to the first device and a second collaboration widget to the second device; and
providing the first and second client devices with access to the collaboration user interface using the first and second collaboration widgets respectively.
